(19) United States
(12) Patent Application Publication
(10) Pub. No.: US 2013/0297262 A1
(43) Pub. Date: Nov. 7, 2013

(54) Pressure Vessel Pipe Connection Selector

(71) Applicants: David L. ALLEN, Humble, TX (US); Purav PATEL, Humble, TX (US)

(72) Inventors: David L. ALLEN, Humble, TX (US); Purav PATEL, Humble, TX (US)

(21) Appl. No.: 13/461,780

(22) Filed: May 2, 2012

(51) Int. Cl. G06F 17/50

(52) U.S. Cl. 703/1

(57) ABSTRACT

A pressure vessel pipe connection selector is disclosed. A pressure vessel may require various connections or nozzles for connecting to a pipe. A selector device includes all necessary data for a user to input design requirements for a pressure vessel pipe connection, and for a specific subset of relevant outputs to be displayed. The relevant outputs can be compared to a list of pressure vessel connection abbreviations or identifiers that can then be used to choose a specific pressure vessel connection that is appropriate for the user's design requirements.

### CROSS-REFERENCE TO RELATED APPLICATIONS

The present application claims priority to provisional patent application No. 61/481,232 filed May 1, 2011, entitled “Pressure Vessel Pipe Connection Selector.”

### STATEMENT REGARDING FEDERALLY SPONSORED RESEARCH OR DEVELOPMENT

Not applicable.

### BACKGROUND

The disclosure relates generally to pressure vessel connections. More particularly, the disclosure relates to methods and devices to aid end-users in selecting the proper pressure vessel connections. Still more particularly, the disclosure relates to methods and devices to aid end-users in correlating the user's design parameters for pressure vessel connections to the pressure vessel connections available from the manufacturer.

Pressure vessels are common throughout the fluid containment, transportation, and delivery industry. Pressure vessels find application in a wide range of sectors, including chemical processing, power generation, and manufacturing to name a few. Pressure vessels are commonly used to mix, to convert, and to store gases, liquids, slurries, and even solids or a combination of these. Pressure vessels must be connected by piping to other pressure vessels and to other parts of a process to receive and to discharge chemicals and materials. Pressure vessel piping connections, some of which are called nozzles, are designed for various pipe sizes and sometimes are specialized for particular applications. Piping connections are selected by designers based on multiple criteria. Choosing the correct piping connection for a pressure vessel can be an involved process for the designer. The multiple criteria and parameters for choosing the correct piping connection must be considered simultaneously. Manufacturers may augment this process by providing catalogs with cross-referenced data tables and charts. The data tables and charts are usually evaluated by the designer or customer by flipping through the tables and charts, selecting the appropriate row and column based on multiple design criteria and parameters. Other data may be offered in a graph, requiring the user to read the abscissa and ordinate values for a particular point on the graph. Manufacturers may offer personal assistance with the selection process. Even so, the process of cross-referencing user design criteria against a manufacturer's available product line is time consuming and subject to human error, especially when the use of multiple charts or tables is necessary. Accordingly, there remains a need in the art for improved methods of correlating design criteria against available manufacturer offerings for pressure vessel pipe connections.

### BRIEF DESCRIPTION OF THE DRAWINGS

For a detailed description of the preferred embodiments of the invention, reference will now be made to the accompanying drawings in which:

FIG. 1 is a plan view of an embodiment of a selector device for choosing pressure vessel connections;

FIG. 2 is a plan view of a second side of the selector of FIG. 1;

FIG. 3 is a plan view of an outer sleeve for the selector of FIG. 1;

FIG. 4 is a plan view of a second embodiment of a selector device for choosing pressure vessel connections; and

FIG. 5 is a schematic illustrating a computer system capable of implementing the selector device of FIG. 4.

### DETAILED DESCRIPTION OF THE DISCLOSED EMBODIMENTS

The following discussion is directed to various embodiments of the invention. The embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment. Components disclosed herein can be used in various combinations for desired results.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

In the following discussion and in the claims, the terms “including” and “comprising” are used in an open-ended fashion, and thus should be interpreted to mean “including, but not limited to . . . .” In addition, the term “couple” or “couples” is intended to mean either an indirect or a direct connection. Thus, if a first device couples to a second device, that connection may be through a direct connection, or through an indirect connection via other devices, components, and connections.

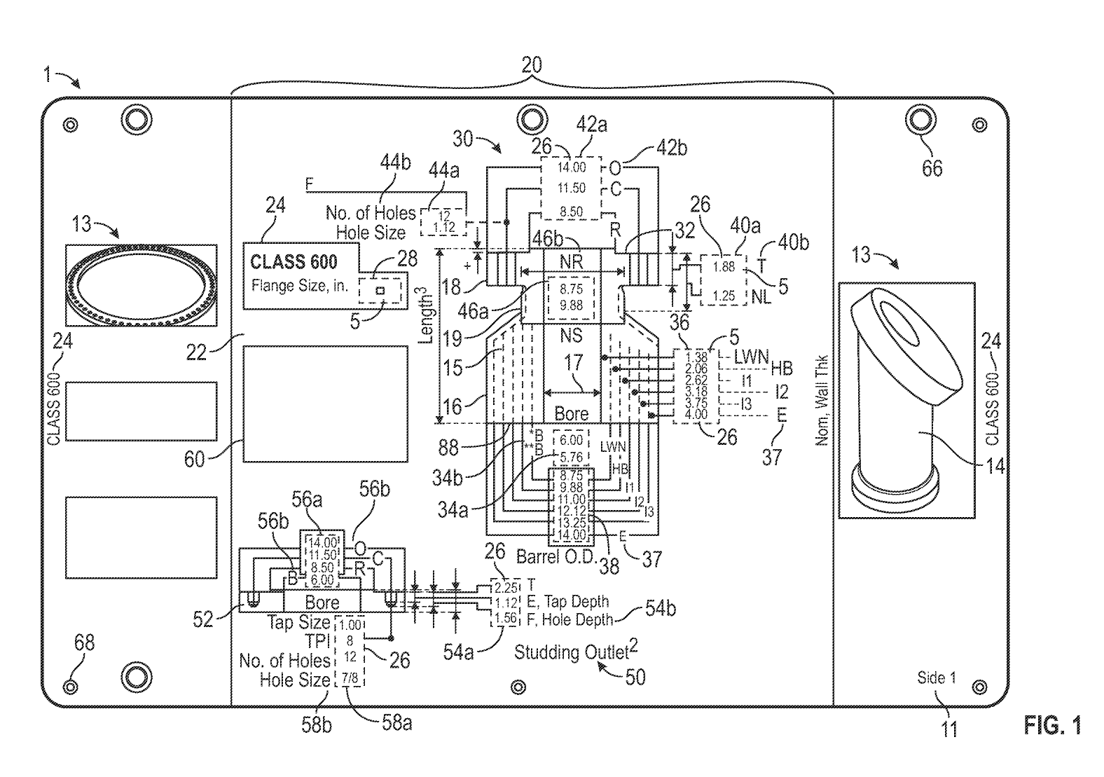

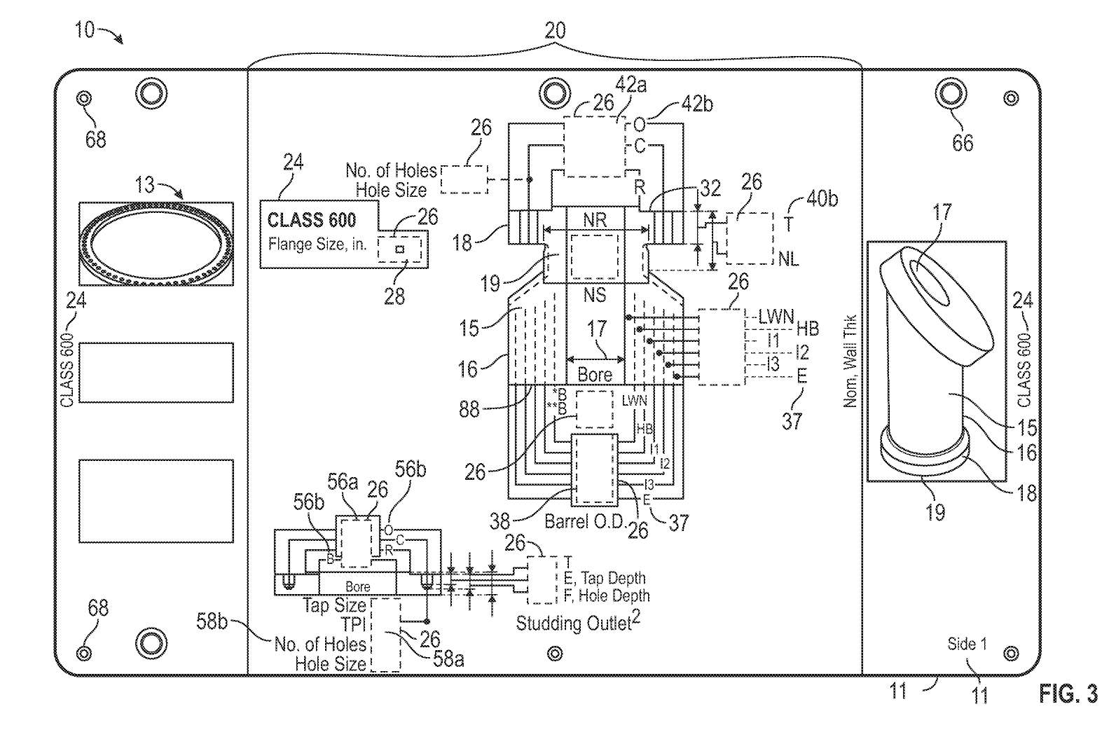

In FIGS. 1 and 3 an example of a pressure vessel connection, or nozzle, is designated as image 32 and is illustrated as part of an embodiment of a pressure vessel pipe connection selector device 1. The pressure vessel connection 32 is shown in cross-section. When a pressure vessel connection 32 is used in industry, a first end 88 is mounted to the pressure vessel, typically by welding. A flange 18 is connected to additional piping, another adjacent pressure vessel, or other equipment (not shown). To facilitate the interconnection, the pressure vessel connection 32 includes a body 15, an outside surface diameter 16, an inside surface diameter 17, the flange (or other external connection) 18, a neck 19, and a wall thickness. Presenting and selecting data that define these features can be automated by a selector device, such as selector device 1 and selector device 101, two embodiments disclosed herein that represent principles of the disclosure.

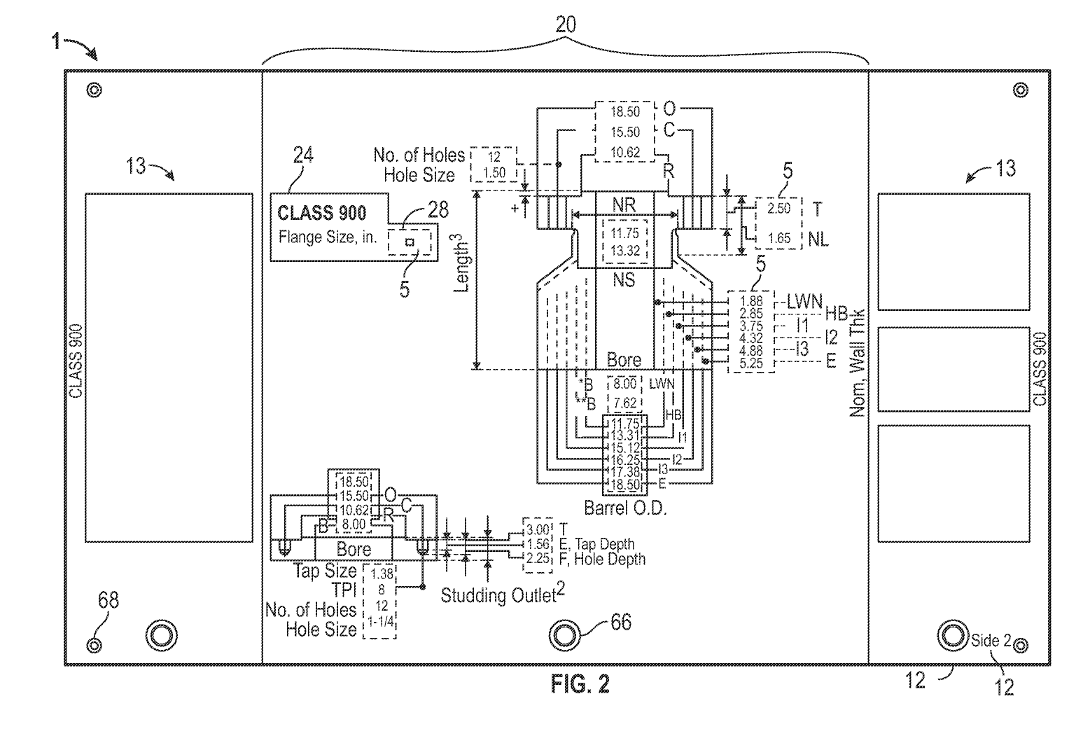

FIG. 1 and FIG. 2 illustrate a first embodiment of a selector used for choosing pressure vessel connections or nozzles. A selector device 1 correlates a user's input design criteria against pre-established manufacturer parameters for pressure vessel pipe connections. That is to say, selector device 1 receives a set of design data, and based on this first set of data, selector device 1 presents a second set of data that describes a piece of equipment that will satisfy the pipe connection design requirements. To operate selector device 1, a user slides a data card 5 relative to a covering card or outer sleeve 10. The covering card or outer sleeve 10 holds the data card 5, which is disposed behind or inside the outer sleeve 10. Data card 5 is typically rigid paper, cardboard, plastic, or another thin material that is printed with parameters for various sizes of pressure vessel connections. The outer sleeve 10 is shown alone, without a data card, in FIG. 3. The outer sleeve 10 is made of a similar material as data card 5 and has a plurality of holes or windows 26 to display data from the data card 5. Each data window 26 of the outer sleeve 10 will be described herein.

The outer sleeve 10 includes a first side 11 (FIG. 1) and a second side 12 (FIG. 2) both with one or more illustration regions 13 and one or more data regions 20. The first side 11 displays data for one or more connector classifications 24 while the second side 12 displays data for one or more different connector classifications 24. Outer sleeve 10 also includes holes 66, which can include support rings, for receiving binder rings (not shown), and fasteners 68, which couple the first side 11 to the second side 12. Fasteners 68 are positioned in a manner that leave adequate space for data card 5 to slide side-to-side while restricting other movement of data card 5. Some or all of the fasteners 68 may be replaced by a folded edge (not shown), by adhesive, or by another means of binding.

Referring to FIG. 1 and FIG. 3, data region 20 of selector device 1 includes sub-regions 22, 60 that can be used for such things as titles, notes for the user, and other informational text. The data region 20 may also include the connector classification 24, a connector size window 28, and data groups for one or more pressure vessel connectors, such as first data group 30 for a first connector and second data group 50 for a second connector. Connector size window 28 displays one of the several connector sizes that can be evaluated for a particular connector classification 24 displayed on selector device 1. The numeric values on data card 5 that are available for display in connector size window 28 are the nominal bore size, i.e., the nominal inside diameter values, for a pressure vessel connection and are also known as the flange size.

The first data group 30 provides information about a first pressure vessel connection that could be selected by the user. First data group 30 includes the representation of the pressure vessel connection 32 and a plurality of the data windows 26 to display and identify a plurality of data values from the data card 5 as will be explained now. One data window 26 is the bore diameter window 34a, which lists available values for the bore or inside diameter of the pressure vessel connection. The values in bore diameter window 34a correspond directly to the value displayed in connection size window 28. Diameter nomenclature 34b and notes, such as those that may be provided in the data sub-region 60, clarify which values in the bore diameter window 34a are available and appropriate for various situations. A wall thicknesses window 36 on the right side of the pressure vessel connection image 32 lists numeric values of wall thickness that are available for the connector. Together, the values in bore diameter window 34a and the values in wall thicknesses window 36 define the barrel outside diameter (OD) which is displayed in barrel OD window 38.

A list 37 of abbreviations, designations, or identifiers for various connection configurations may be assigned by the manufacturer to represent the various pressure vessel connections available to the customer. For some embodiments of selector device 1, the connection configurations 37 include LWN, HB, I₁, I₂, I₃, and E. Each different connection configuration 37 corresponds to an existing pressure vessel connection of the manufacturer with the prescribed wall thickness values 36, or, equivalently, barrel outside diameter (OD) values 38.

Continuing with first data group 30 in FIG. 1, the flange for the pressure vessel connection is defined by data values in a plurality of additional data windows 26, including flange length window 40a accompanied by flange length nomenclature 40b, flange face window 42a accompanied by flange face nomenclature 42b, and flange bolt hole window 44a accompanied by flange bolt hole nomenclature 44b. A neck parameter window 46a and the corresponding neck nomenclature 46b are also provided. The data values displayed in windows 40a, 42a, 44a, 46a are printed on the sliding, inner data card 5. Nomenclature lists 40b, 42b, 44b, 46b are printed on the outer sleeve 10 as shown in FIG. 3.

The second data group 50 provides information about a second pressure vessel connector, e.g., a “studding outlet,” that could be selected by the user. Second data group 50 includes an image 52 and a plurality of data windows 26 to display and identify a plurality of data values from the data card 5. Data windows 26 in second data group 50 include flange length window 54a identified by flange length nomenclature 54b, flange face window 56a identified by flange face nomenclature 56b, and flange bolt hole window 58a identified by flange bolt hole nomenclature 58b.

With the working components of selector device 1 now defined, the operation of selector device 1 will be explained. Before using selector device 1, a user must independently determine the following design parameters: the connector classification, the connector size (i.e. flange size or nominal inside diameter), and the wall thickness required for a particular task. The user then picks a selector device 1 and picks a first side 11 or second side 12 so that the connector classification 24 matches the corresponding design parameter. The user then slides the data card 5 with respect to the outer sleeve 10 until the preferred or required connector size is displayed in the connector size window 28. The user then compares the design value for wall thickness against the values displayed in wall thickness window 36, choosing the value that matches or just exceeds the design value, insuring sufficient wall strength. The corresponding connector configuration abbreviation 37 is read by the user and is used to facilitate a discussion or to initiate an order with the manufacturer. In some embodiments, the connector configuration abbreviation 37 represents and identifies one of a plurality of connections in the manufacturer's inventory. The other values presented in windows 34a, 38, 42a, 44a, 46a, 54a, 56a, and 58a help the user integrate the selected pressure vessel connector with other equipment.

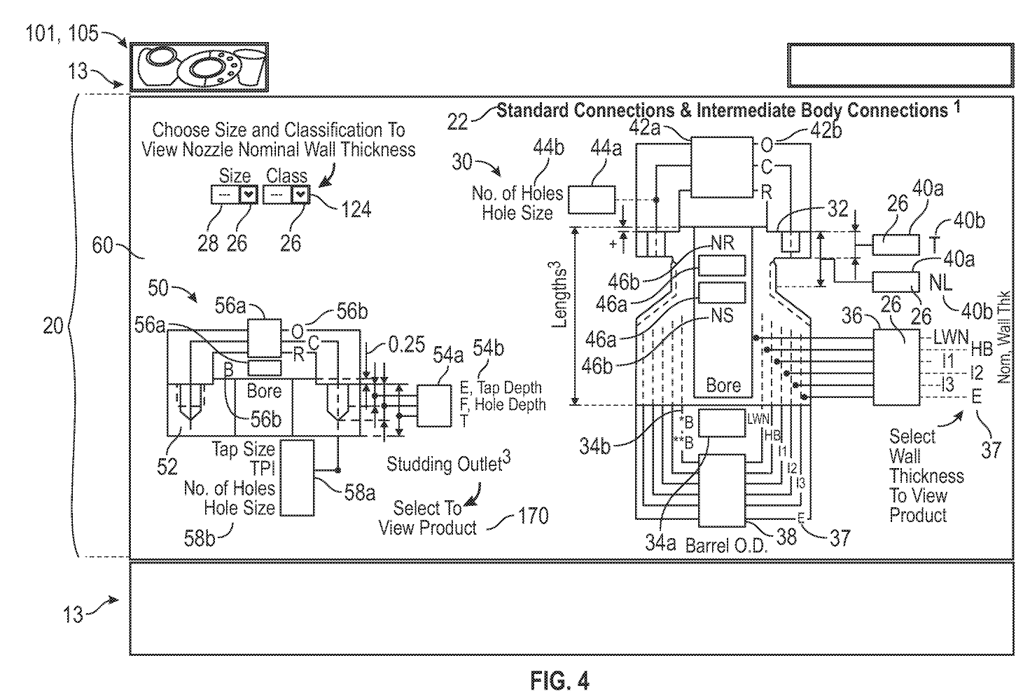

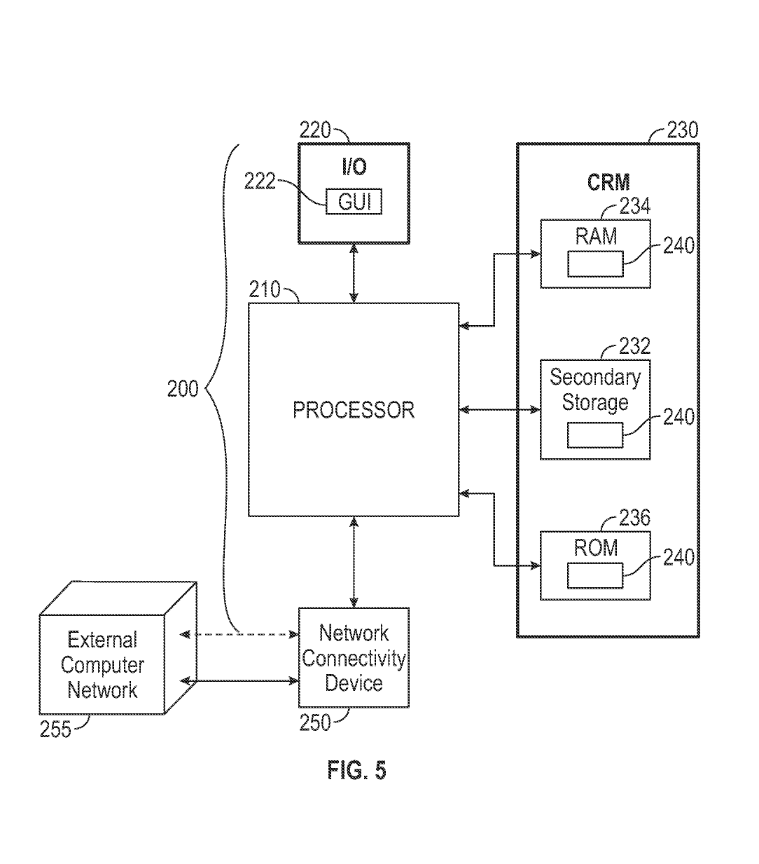

Referring to FIG. 4 and then to FIG. 5, a second embodiment of the selector device for choosing pressure vessel connections or nozzles, i.e., selector device 101, is shown. In some embodiments, the selector device 101 is electronic. In some embodiments, the selector device 101 is packaged as computer instruction code or a software program that operates on a computer system 200 that has sufficient processing power, memory resources, input/output capability, and network throughput capability to handle the necessary workload placed. Selector device 101 includes a graphical user interface (GUI), specifically GUI 105, to exchange data or information with the user.

FIG. 4 presents one portion or one screen or one page of the GUI 105 of selector device 101. GUI 105 has a plurality of pages that can be viewed when activated by the user at an appropriate time. In addition to GUI 105, selector device 101 includes manufacturer's data for various sizes of pressure vessel connections and computer instructions to locate and process data and to exchange data with the user. Like selector device 1, selector device 101 correlates input design criteria (i.e., the user's data) against pre-established parameters (i.e., the manufacturer's data) for pressure vessel pipe connections. That is to say, selector device 101 receives a set of design data, and based on this first set of data, selector device 101, via GUI 105, presents a second set of data that describes a piece of equipment that will satisfy the design requirements. GUI 105 has a plurality of data windows 26 to receive and display user data. GUI 105 also has a plurality data windows 26 to display manufacturer's prescribed data and, in some embodiments, data that is computed or developed during the execution of the software. Each data window 26 will be described next.

Referring to FIG. 4, GUI 105 is generally similar to selector device 1 in layout, functionality, and purpose. GUI 105 includes one or more illustration regions 13 and one or more data regions 20. Data region 20 of selector device 101 includes a sub-region 22, a selectable connector classification window 124, a selectable connector size window 28, a sub-region 60 for the user, and data groups for one or more pressure vessel connectors, such as first data group 30 for a first connector and second data group 50 for a second connector. The numeric values available for selection in connector size window 28 are the nominal bore size, i.e., the nominal inside diameter values, for a pressure vessel connector and are also known as the flange size.

The first data group 30 provides information about a first pressure vessel connector that could be selected by the user. First data group 30 includes an image 32 and a plurality of data windows 26 and corresponding nomenclature lists having the same purpose and cross-correlation as described for data windows 26 of selector device 1. Data windows 26 and nomenclature lists in selector device 101 include bore diameter window 34a, diameter nomenclature 34b, wall thicknesses window 36, abbreviations for connector configurations 37, barrel OD window 38, flange length window 40a, flange length nomenclature 40b, flange face window 42a, flange face nomenclature 42b, flange bolt hole window 44a, flange bolt hole nomenclature 44b, a neck parameter window 46a, and nomenclature 46b.

The second data group 50 provides information about a second pressure vessel connector, e.g., a “studding outlet,” that could be selected by the user. Second data group 50 includes an image 52 and a plurality of data windows 26 and nomenclature lists, including a flange length window 54a, flange length nomenclature 54b, flange face window 56a, flange face nomenclature 56b, flange bolt hole window 58a, and flange bolt hole nomenclature 58b.

With the working components of selector device 101 now defined, the operation of selector device 101 will be explained. Before using selector device 101, in some embodiments, a user must independently determine the following design parameters: the connector classification, the connector size (i.e., flange size or nominal inside diameter), and the wall thickness required for a particular task. The user then picks the connector classification from among the values available in a prescribed “pull-down” list embedded in window 124, matching the chosen value to the corresponding design parameter. The user then picks the preferred or required connector size from among the values available in a prescribed “pull-down” list embedded in window 28. Selector device 101 then populates the other data windows 26 with the appropriate manufacturer data. The user then compares the design value for wall thickness against the values displayed in wall thickness window 36, choosing the value that matches or just exceeds the design value, insuring sufficient wall strength. From this choice, the corresponding connector configuration 37 abbreviation is read by the user and is used to facilitate a discussion or to initiate an order with the manufacturer. The other values presented in windows 34a, 38, 42a, 44a, 46a, 54a, 56a, and 58a, help the user integrate the selected pressure vessel connector with other equipment.

In addition, after the user has set the appropriate parameters, and selector device 101 has populated the remaining data windows 26, the user to can view a specific product that matches the user's requirements. Referring still to FIG. 4, each abbreviation in the connector configuration 37 list is established as a group of computer page links. When a user presses one of the computer page links, the user is taken to another portion of the GUI 105, to another screen view or page (not shown) that displays a picture or image of one of the standard pressure vessel connections configurations, such as LWN, HB, I₁, I₂, I₃, and E. The newly displayed GUI 105 page shows one actual connection along with corresponding dimensions and characteristics. This display is distinct from the primary GUI 105 page (FIG. 4) that has the multiple possible dimensions corresponding to the multiple items in the connector configuration 37 list. From this newly displayed GUI page, the user may also make a bid inquiry or request a quote for the connection. Also on this GUI page, the user may revise the size of the connection, to display a corresponding new connection in the same class, using a pull-down list in another connector size window 28.

Returning to the primary GUI 105 page shown in FIG. 4, a separate computer link 170 is provided for the second pressure vessel connector, e.g., a “studding outlet.” Again, unlike the multiple data shown in second data group 50, computer link 170 brings the user to another GUI page (not shown) with the second connector alone, along with the specific size data that corresponds to the chosen size and class of connection, specified previously in windows 28 and 124, respectively. Also on this GUI page, the user may revise the size of the connection using a pull-down list in another connector size window 28 to display another new connection in the same classification. A picture of the second connector is displayed or available via another computer page link (not shown).

Referring to FIG. 5, a computer system 200 that can operate selector device 101 includes a processor 210 (which may be referred to as a central processor unit or CPU) that is in communication with a computer-readable medium 230. The computer-readable medium 230 may comprise memory devices including secondary storage 232, read-only memory (ROM) 236, and random access memory (RAM) 234. The processor is further in communication with input/output (I/O) 220 devices and, possibly, computer network connectivity devices 350. The processor may be implemented as one or more CPU integrated circuit chips and may be supported by other integrated circuit chips (not shown).

The computer-readable medium 230 stores computer instructions or software programs and/or data 240 that control the functions of the processor 210. As stated, computer-readable medium 230 comprises several components. The ROM 236 is used to store fundamental, seldom-changing computer instructions 240 and perhaps data. ROM 236 is a non-volatile memory device, which may have a small memory capacity relative to the larger memory capacity of secondary storage 232. The secondary storage 232 is may comprise one or more disk drives, compact disc drives, tape drives, and/or memory connected through a universal serial bus (USB) interface. In some cases, secondary storage 232 refers to both a machine (“drive”) and a removable storage medium (e.g. floppy disk or compact disc). Secondary storage 232 provides non-volatile storage of data and computer instructions 240, which are loaded into RAM 234 when such programs are selected for execution. The RAM 234 is used for volatile (temporary) storage while the processor 210 operates. Secondary storage 232 is also used as an over-flow storage device if RAM 234 is not large enough to hold all working data and computer instructions 240 being used by the processor 210.

In one scenario, software programs 240 include selector device 101 disclosed herein. Once loaded in to RAM 234 and accessed by the processor 210, the software programs 240 cause the processor 210 to perform any of the steps described in this disclosure.

I/O refers to the exchange of data between two separate entities. The first entity of I/O is computer system 200, including processor 210. The second entity is external to the computer system 200 and may be a user or a separate data generating or data manipulating device such as a real-time process data acquisition system (not shown). I/O 220 devices may include printers, video monitors, liquid crystal displays (LCDs), touch screen displays, keyboards, keypads, switches, dials, mice, track balls, voice recognizers, card readers, paper tape readers, or other devices that perform input and/or output functions. If the computer instructions 240 that are operating in the processor 210 at a particular time period include a graphical user interface (GUI) 222, then I/O 220 will display the GUI 222. In the case of selector device 101, the GUI is GUI 105 in FIG. 4, which is described above.

Returning to FIG. 5, the network connectivity devices 350 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and other computer network connection devices. These network connectivity 350 devices may enable the local computer system 200 and its processor 210 to communicate with an external network 355 of one or more other computer systems. The network connection may be direct or may be via an intranet comprising multiple computer systems. When connected to an external network 355, processor 210 may receive information from or may output information to the network 355 in the course of performing software programs 240 that include selector device 101. Alternatively, selector device 101 may be operated on a computer of the external network 355, which may exchange data with the local computer system 200.

The embodiments herein may simplify a variety of calculations and data-correlation functions related to selecting pressure vessel pipe connections. The embodiments provide easy solutions to a user's query based on input data. When pressure vessel pipe connection input data must be cross-referenced to a large quantity of correlation data, typically in the form of large charts or tables, the embodiments described herein may be employed to simplify or automate the process of cross-referencing for the user. As described herein, certain user input about the design requirements of a needed pressure vessel connection are provided to output a certain subset of all of the data related to a plurality of pressure vessel configurations offered by a manufacturer. The subset of output data can then be correlated with pressure vessel identifiers provided by the manufacturer, each identifier representing a specific pressure vessel connection offered by the manufacturer. The correlator tool can be the outer sleeve and inner slider combination as described herein, or the computer and software program as described herein.

In some embodiments, a pressure vessel pipe connection selector includes a first set of data including design parameters for a pressure vessel connection, a second set of data including manufacturer data for the pressure vessel connection, and a correlator tool to correlate the first and second sets of data to a pressure vessel connection identifier. The correlator tool may include a first member slidable within a second member to correlate the design parameters of a desired pressure vessel pipe connection with an identifier for an existing pressure vessel pipe connection. In some embodiments, a computer and a computer readable medium is used for implementing the pressure vessel pipe connection selector.

In some embodiments, a pressure vessel pipe connection selector includes a first member including a first input data for a pressure vessel pipe connection, and a second member including a second input data for the pressure vessel pipe connection and a set of identifiers for existing pressure vessel pipe connections, wherein the first member is slidable within the second member to correlate the first and second input data with the identifiers for the existing pressure vessel pipe connection. In some embodiments, a computer and a computer readable medium is used for correlating the first and second input data with the identifiers for the existing pressure vessel pipe connection of claim 4.

In some embodiments, a method for selecting an existing pressure vessel pipe connection includes determining design parameters for a desired pressure vessel pipe connection, inputting and displaying first data from the design parameters into a pressure vessel pipe connection selector, displaying second data from the design parameters, comparing the second data from the design parameters with a set of identifiers for existing pressure vessel pipe connections, and selecting the identifier for the existing pressure vessel pipe connection based on the comparison. The method may further comprise sliding a first member relative to a second member to display the first and second data. The method may further comprise electronically inputting and displaying the first data, electronically displaying the second data in response to inputting and displaying the first data, and electronically comparing the second data with the set of identifiers.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Examples of possible modifications for the selector include adding or removing data windows. Accordingly, the scope of protection is not limited to the embodiments described herein, but is only limited by the claims that follow, the scope of which shall include all equivalents of the subject matter of the claims.

What is claimed is:

1. A pressure vessel pipe connection selector comprising:
a first set of data including design parameters for a pressure vessel connection;
a second set of data including manufacturer data for the pressure vessel connection; and
a correlator tool to correlate the first and second sets of data to a pressure vessel connection identifier.

2. The selector of claim 1 wherein the correlator tool comprises a first member slidable within a second member to correlate the design parameters of a desired pressure vessel pipe connection with an identifier for an existing pressure vessel pipe connection.

3. A computer and a computer readable medium for implementing the pressure vessel pipe connection selector of claim 1.

4. A pressure vessel pipe connection selector comprising:
a first member including a first input data for a pressure vessel pipe connection; and
a second member including a second input data for the pressure vessel pipe connection and a set of identifiers for existing pressure vessel pipe connections;
wherein the first member is slidable within the second member to correlate the first and second input data with the identifiers for the existing pressure vessel pipe connection.

5. A computer and a computer readable medium for correlating the first and second input data with the identifiers for the existing pressure vessel pipe connection of claim 4.

6. A method for selecting an existing pressure vessel pipe connection comprising:
determining design parameters for a desired pressure vessel pipe connection;
inputting and displaying first data from the design parameters into a pressure vessel pipe connection selector;
displaying second data from the design parameters;
comparing the second data from the design parameters with a set of identifiers for existing pressure vessel pipe connections; and
selecting the identifier for the existing pressure vessel pipe connection based on the comparison.

7. The method of claim 6 further comprising sliding a first member relative to a second member to display the first and second data.

8. The method of claim 6 further comprising electronically inputting and displaying the first data, electronically displaying the second data in response to inputting and displaying the first data, and electronically comparing the second data with the set of identifiers.
